(19) United States
(12) Patent Application Publication
(10) Pub. No.: US 2021/0156728 A1
(43) Pub. Date: May 27, 2021

(54) RAIL-MOUNTED LOAD-CELL SCALES

(71) Applicant: OBSHCHESTVO S OGRANICHENNOJ OTVETSTVENNOST'YU ‘STATERA’, Rostov-na-Donu (RU)

(72) Inventor: Yurij Petrovich STEPANENKO, Rostov-na-Donu (RU)

(21) Appl. No.: 16/643,980

(22) PCT Filed: Aug. 9, 2019
(86) PCT No.: PCT/RU2019/000565

§ 371 Date: Mar. 3, 2020

(30) Foreign Application Priority Data
Aug. 14, 2018 (RU) 2018129553

(51) Int. Cl. G01G 19/04; G01G 3/14

(52) U.S. Cl. CPC G01G 19/045; G01G 3/1402

(57) ABSTRACT

The invention relates to apparatuses for the wheel-by-wheel weighing of railway wagons during motion. Essence: the scales comprise deformation sensors (2), temperature sensors (3) secured to working rails (1) by an adhesive process, polymer plates (6), metal plates (7) and controllers which are arranged externally to a rail track. Circuit boards (5) of the controllers are arranged on the working rails (1) in recesses formed by the polymer plates (6) and metal plates (7). Furthermore, the deformation sensors (2), temperature sensors (3) and circuit boards (5) of the controllers are hermetically encapsulated by means of said set of plates (6, 7). Technical result: simplification of the design and installation of scales and reduction in the probability of electrical interference in measuring networks.

### CROSS-REFERENCE TO RELATED APPLICATIONS

The present patent application is A National stage of the PCT application PCT/RU2019/000565 filed Aug. 9, 2019 which claims priority to Russian patent application RU 2018129553 filed Aug. 14, 2018, all of which incorporated herein by reference by their entirety.

### TECHNICAL FIELD

Rail-mounted load-cell scales are intended for weighing railway cars wheel by wheel during motion (e.g., an uncoupled car, a coupled car in a rolling stock, and the rolling stock as a whole). Software of the scales performs a set of service functions: measuring speeds of all axles, wheel and axle loads, as well as generating some characteristics of car failure and car loading correctness. The software eventually identifies a weighed rolling stock car by car. The invention can be used at enterprises of different branches of industry, such as agriculture and transport. With respect to the service functions, the scales can be used as a means for monitoring the rolling stock.

### BACKGROUND

There are known rail-mounted load-cell scales (type VD-30, company “Avitek-Plus”, www.avitec.ru), which comprise measuring rails mounted in a rail track cut-section and electronic equipment (a controller, a personal computer, communication cables) for weighing cars during motion and under static conditions. The controller is arranged near a rail track, while the computer is arranged at a distance up to 1 km. On top of that, the scales are equipped with a car-wheel position sensor (for a static weighing mode) and a temperature sensor (for compensating a temperature influence on measurement accuracy). A motion speed is not more than 40 km/h in case of weighing and is unlimited without weighing.

However, the measuring rail is ambiguously defined in the specification of the scales of this type as follows: “rail-mounted weight-measuring strain sensor”, “weighing load-cell rail”, “weight-measuring strain sensor made as a rail”, “weighing rail”, and finally “measuring rail”. Practically speaking, two measuring rails constitute a load receptor. In all these cases, the measuring rail is a specialized high-technology measuring device.

The measuring rails are equipped with strain sensors providing data about shearing forces in the rail serving as a multisupport beam to the electronic equipment. These sensors are arranged in the region of a rail neutral axis, approximately in the middle of a rail web. As a rule, an opening-concentrator is drilled in this region, which increases controllable strains by at least 4 times. There are 4 resistive-strain sensors adhered to the internal surface of the opening, with the resistive-strain sensors being arranged along the contour of the opening and interconnected in a full bridge. The whole group of the resistive-strain sensors is at 45° with respect to a vertical axis of symmetry, which allows it to measure (accurate to a coefficient) maximum shear strains (and eventually, the shearing force). Two sensors spaced form each other along the rail length at a distance of about 0.8 m constitute a measuring section (there is no cross sleeper under this section, since cross sleepers are arranged at a distance of more than 1 m). The difference of signals from the both sensors represents the wheel load on this section. The second rail is identical to the first one. The measuring rail has a minimum length of about 6 m and a maximum length of about 18 m. A number of measuring sections varies from 1 to 8 according to modifications of the scales. The six modifications of the scales provide accuracy classes 0.2, 0.5, 1 and 2 according to State Standard (GosStandart) 8.647-2015.

The drawbacks of the above-described scales are down to the following. It is possible to perform an additional machining operation on the rail and install the strain sensors thereon only under the conditions of complex manufacture. Making the cut-section of the road track and mounting the measuring rails in this cut-section require blocking the traffic for at least 4 hours. Finally, the last drawback is a deviation from the standard cross-sleeper arrangement, i.e. a twofold increase in the distance between the cross sleepers, which is highly undesirable in all case and totally unallowable in the absence of motion-speed constraints on the measuring section. Moreover, multimeter communication links between the analog strain sensors and the controller increase the risk of electrical interferences and significantly complexify the installation of the scales.

There are also known rail-mounted load-cell scales, which are described in application RU2008144076, dated May 11, 2008 and entitled “Rail-mounted load-cell scales”.

These scales comprise resistive-strain sensors which, contrary to the scales of type VD-30, are adhered to webs of working rails during its normal operation (without having to block the rolling-stock traffic). The sensors are encapsulated by means of a set of polymer and metal plates. Electronic equipment is arranged in the same manner as in the scales of type VD-30, namely: controllers are arranged to the outside of the rail track. This circumstance is an essential drawback of the scales for the following reasons: 8 communication cables between the sensors and the controllers fill the space between cross sleepers on a measuring section, thereby complexifying the installation of the scales and increasing the risk of electrical interferences.

The objective of the invention is to simplify the design and installation of scales and reduce the probability of electrical interferences in measuring circuits.

The technical result of the invention amounts to the arrangement of measuring equipment locally in the region of a measuring section of a rail.

### SUMMARY

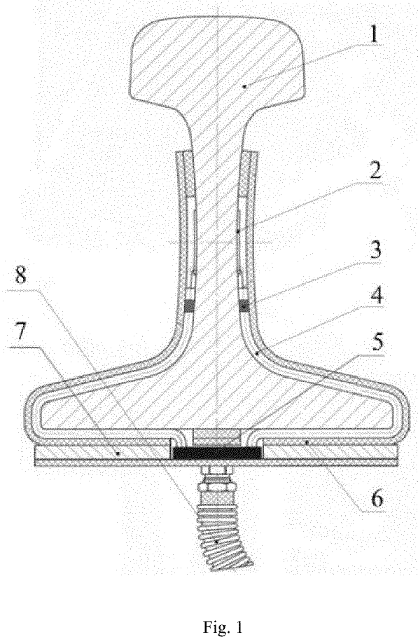

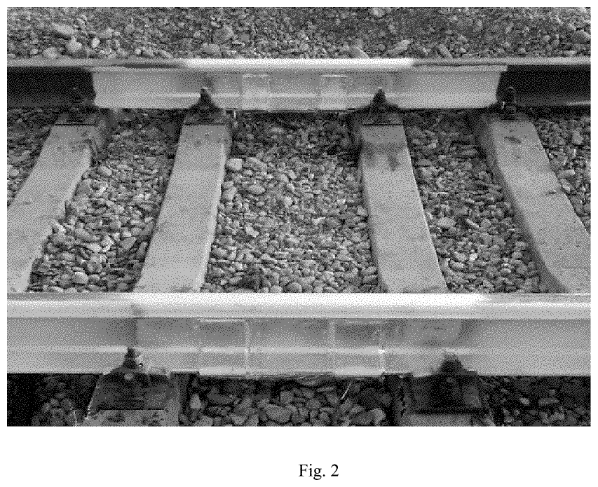

The essence of the invention is that circuit boards of controllers are arranged on both rails under a rail base in recesses formed by a set of protective plates, as shown (see FIG. 1) in a cross-section of a rail 1 in the region of a strain sensor 2 (patent RU2349874, entitled “Resistive-strain sensor”). The strain sensor 2 is attached to the web of the rail 1, and a temperature sensor 3 is coupled to a multicore communication cable 4 over which signals from the both sensors are provided to a circuit board 5 of a controller. A strain sensor and a temperature sensor on the opposite side of the rail 1 are identical to the strain sensor 2 and the temperature sensor 3. The whole group of the sensors is programmatically combined into a shearing-force sensor in the section shown in FIG. 1. A second shearing-force sensor is identical to the first one and spaced from the first one (within the space between cross sleepers) at a distance of not less than 0.2 m. Polymer plates 6 and a metal plate 7 constitute a set of plates by which four strain sensors, four temperature sensors and a circuit board of a controller are encapsulated in a sealed manner. The output of the circuit board 5 of the controller is provided with a single-core coaxial cable 8 coupled to a computer and a power supply. In total, the above-listed components constitute a wheel-load sensor (WLS). The external view of the both WLSs on the measuring section of the scales is shown in FIG. 2. The coaxial cables 8 (shown in FIG. 1) are not shown in FIG. 2.

What is claimed is:

1. Rail-mounted load-cell scales, comprising: strain sensors, temperature sensors secured to working rails by an adhesive process and encapsulated by means of a set of metal and polymer plates, and controllers arranged externally to a rail track, characterized in that circuit boards of the controllers are arranged on the working rails in recesses of said set of plates.
